(19) United States
(12) Patent Application Publication
(10) Pub. No.: US 2003/0045236 A1
(43) Pub. Date: Mar. 6, 2003

(54) Wireless peripheral with inbuilt driver

(76) Inventors: Yuan-Jung Chang, Hsinchuang City (TW); Chun-Wei Kao, Chungho City (TW); Chia-Ming Chung, Sanchung City (TW); Shyhjir Ferng, Hsintien City (TW); Chien-Kun Liao, Panchiao City (TW); Bee Yeong Khoo, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/996,890

(22) Filed: Nov. 30, 2001

(30) Foreign Application Priority Data
Aug. 29, 2001 (TW) 90214767

(51) Int. Cl. H04B 5/00

(52) U.S. Cl. 455/41; 455/500; 455/557

(57) ABSTRACT

The present invention provides a wireless peripheral with inbuilt drivers of a host computer. The host computer has a wireless transmission module capable of transmitting control information to control the peripheral. The wireless peripheral comprises a wireless transmission module, a central processing unit, a database, and a renewal unit. The wireless transmission module can communicate with the wireless transmission module of the computer. The central processing unit is a control center of the whole peripheral. The database stores one or more driver. The renewal unit can store or record new drivers in the database via the host computer. The drivers will always accompany the peripheral. A host computer is not necessary to install drivers from floppy disks or CDs in order to use peripherals, and the trouble of missing the drivers will not arise; hence operations of peripheral achieve the object of “Plug-and-Play” or “Turn-on-and-Play”.

### FIELD OF THE INVENTION

The present invention relates to a wireless peripheral with inbuilt drivers and, more particularly, to a wireless peripheral having various kinds of inbuilt drivers, which can be installed on a host computer automatically so that the peripheral can be used without installing any program.

### BACKGROUND OF THE INVENTION

In order to use any device or peripheral on a computer, it is necessary to connect the device with the computer, and then install a driver and set up some configurations at first time. Generally speaking, the driver is provided by the device manufacturer and stored in storage media such as floppy disks and CDs bundled with the device, or can be downloaded from a website specified by the manufacturer. For example, a computer should be installed with a correct driver and application software before communicating with a printer successfully. After the installation is finished, the driver can be kept for next time use. Once the operation system needs to be reinstalled on the computer or the peripheral is to be installed on another computer, it is necessary to use again the floppy disks, CDs, or other storage media provided by the manufacturer. In case that the floppy disks or CDs cannot be found or are damaged, the driver file cannot be accessed. Hence, the peripheral cannot be used. This problem exists if the driver is stored in floppy disks, CDs, or other storage media. Additionally, if the manufacturer provides a new driver to be downloaded by a user from a website for upgrade, it is also necessary to store the new driver in floppy disks, CDs, or other storage media. Therefore, the above problem also exists.

There is one technique so-called Plug-and Play interface such as universal serial bus (USB) interface. A personal computer uses the USB interface to connect with other devices, but the drivers need to be installed inside first; otherwise, the computer will ask users to install needed driver when a new or an unsupported device is being connected. Hence, if a new device with driver inside is connected with computer, the driver will be transmitted and installed automatically without user operations. In this method, we can really call it Plug-and-Play.

Additionally, due to vigorous progress of wireless technology, many peripherals use wireless technology for connection with a computer. For example, when a wireless mouse is to be used at first time on a computer, it is necessary to install a pair of emitter and receiver devices for letting the wireless mouse communicate with the computer, and then install a driver of the wireless mouse. The above procedures are very difficult for users not familiar with the operation of computer. This problem should be handled by device developers. Accordingly, the present invention aims to provide a wireless peripheral with inbuilt drivers. By utilizing existent technology of wireless communication protocols, the drivers and some configuration setups stored on the wireless peripheral so that a user turns on the wireless peripheral, then the wireless peripheral is ready to be used by a computer without the need of providing drivers or some configuration setups on storage media like floppy disks.

### SUMMARY OF THE INVENTION

The primary object of the present invention is to provide a wireless peripheral with inbuilt drivers, which will be transferred to and be installed on a host computer when the wireless peripheral connects with the host computer. Therefore, it is not necessary for a user to install any software stored on storage media; moreover, wherever the wireless peripheral goes, the wireless peripheral can be used.

The secondary object of the present invention is to provide a wireless peripheral with inbuilt drivers, wherein drivers always accompany the wireless peripheral so that they will be lost, and it is not necessary to especially attach them or keep them.

Another object of the present invention is to provide a wireless peripheral with inbuilt drivers, wherein drivers inbuilt in the wireless peripheral can be renewed or upgraded by a host computer in wireless transmission way.

The present invention is characterized in that a wireless peripheral device with inbuilt driver is considered as a peripheral device of a host computer. The host computer has a wireless transmission module capable of transmitting control information to control operations of the wireless peripheral. The wireless peripheral comprises a wireless transmission module, a central processing unit, a database, and a renewal unit. The wireless transmission module can communicate with the wireless transmission module of the host computer. The central processing unit is a control center of the wireless peripheral, and can perform transmission of control commands, installation or renewal of drivers, and retrieval of parameters of the host computer. The database stores one or more driver, and also has memory and storage function to store functional information of the host computer or installation information of the drivers. The renewal unit can store or record new drivers in the database through the host computer's transmission. The drivers always accompany the peripheral. Therefore, it is not necessary to install drivers from floppy disks or CDs, and the trouble of missing the drivers will not arise.

The various objects and advantages of the present invention will be more readily understood from the following detailed description when read in conjunction with the appended drawing, in which:

### BRIEF DESCRIPTION OF THE DRAWINGS

FIG. 1 is an architecture diagram of a wireless peripheral with inbuilt drivers of the present invention;

FIG. 2 is a flowchart of automatically installing a wireless peripheral of the present invention on a host computer; and

FIGS. 3A, 3B, and 3C are diagrams showing the steps of renewing drivers in a wireless peripheral of the present invention.

### DETAILED DESCRIPTION OF THE PREFERRED EMBODIMENTS

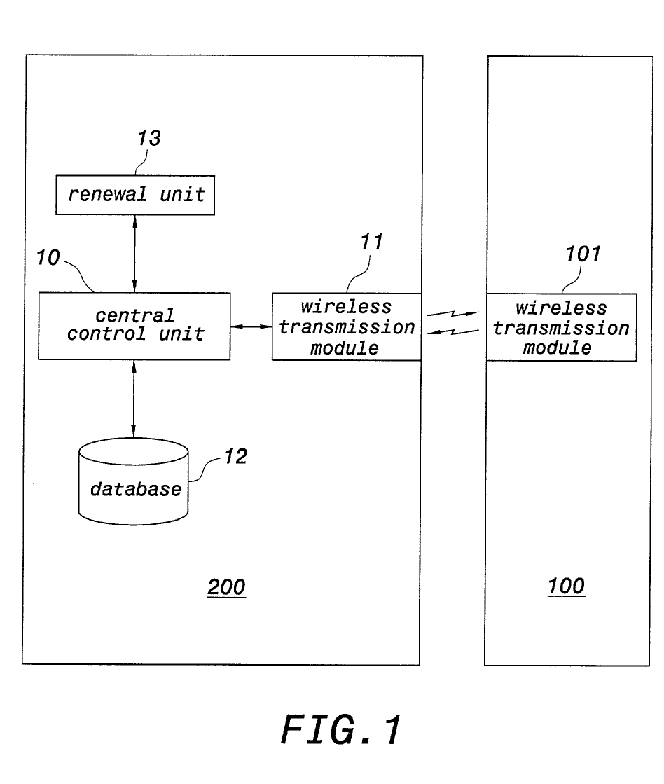

FIG. 1 is an architecture diagram of a wireless peripheral with inbuilt drivers according to a preferred embodiment of the present invention. This embodiment exemplifies the present invention with wireless transmission, but wireless transmission can be replaced with wired I/O interface. The present invention uses a host computer 100 having a wireless transmission module 101 to perform wireless communication with a wireless peripheral 200 for transmission or reception of information. Communication protocols used by the wireless transmission module 101 include infrared direct access (IrDA), bluetooth, 802.11x, radio frequency (RF), Hiper LAN, infrared (IR), or laser transmission. The host computer 100 can be a computer equipment such as a desktop computer, a mainframe, a server, or a portable computer, or a small personal equipment such as a handheld computer, a personal digital assistant (PDA), or a mobile phone.

The wireless peripheral 200 can be a computer peripheral such as a printer, a screen, a digital board, a mouse, a scanner, a modem, a network equipment, or a small personal equipment such as a handheld computer, a PDA, or a mobile phone. The wireless peripheral 200 comprises mainly a central control unit 10, a wireless transmission module 11, and a database 12. The central control unit 10 is a control center of the wireless peripheral, and can perform transmission of control commands to the host computer 100, installation or renewal of drivers, and retrieval of parameters of the host computer 100 through the wireless transmission modules. The wireless transmission module 11 can perform wireless transmission of information with the wireless transmission module 101 of the host computer 100. The database 12 stores one or more drivers; moreover, the database 12 has memory storage functionalities which can store functional properties or driver's installation information of a computer. The database 12 can use a media equipment having the function of storing data such as an electrically erasable programmable read only memory (EEPROM), a flash memory, a floppy disk, a hard disk, an optical disk (CD/VCD/DVD), a portable flash storage media (e.g., a CF card, a SM card, a Secure Digital, a Multi Media Card, a Memory Stick, or a Memory Stick Duo).

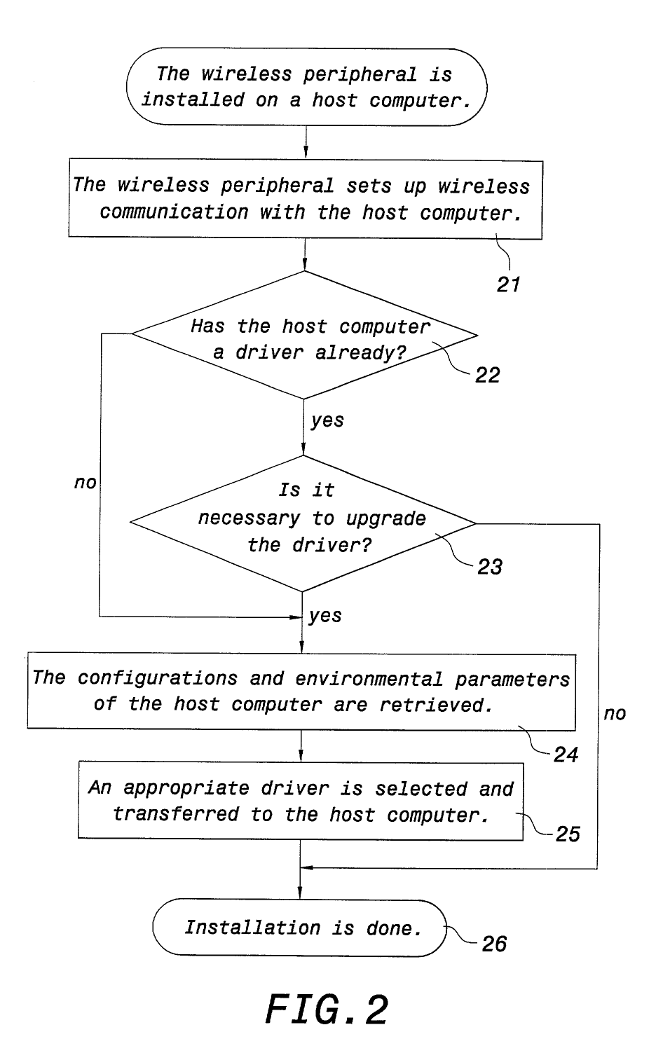

As shown in FIG. 2, when the wireless peripheral 200 of the present invention is to be installed on the host computer 100, the wireless peripheral 200 needs to first set up wireless communication with the wireless peripheral 200 (21). Next, the wireless peripheral 200 asks whether the host computer 100 has a driver capable of driving the wireless peripheral 200 (22). If the answer is yes, the wireless peripheral 200 further asks whether the driver needs to be renewed (23). If the host computer 100 has a driver or the previously installed driver needs to be renewed, the configurations and environmental parameters of the host computer 100 are retrieved (24). Finally, a driver suitable to the operation system of the host computer 100 is selected and transferred to the host computer 100 (25). For example, if the host computer 100 is a Window98 computer, the wireless peripheral 200 selects a driver capable of being installed in the Window 98 computer and transfers it to the host computer 100. If the host computer 100 already has a driver not requiring renewal, installation of the wireless peripheral is done (26). Installation of the wireless peripheral 200 on the host computer 100 can thus be automatically installed without the need of installing any driver by a user. Although the present invention is exemplified with a wireless peripheral, it can also apply to a wired peripheral to achieve the real object of “Turn-on-and-Play” or “Plug-and-Play”.

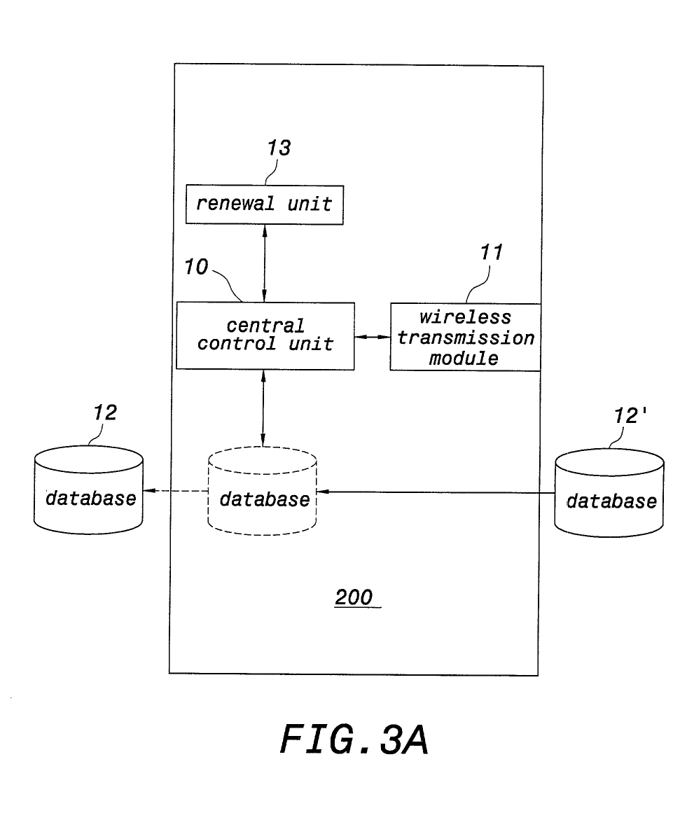

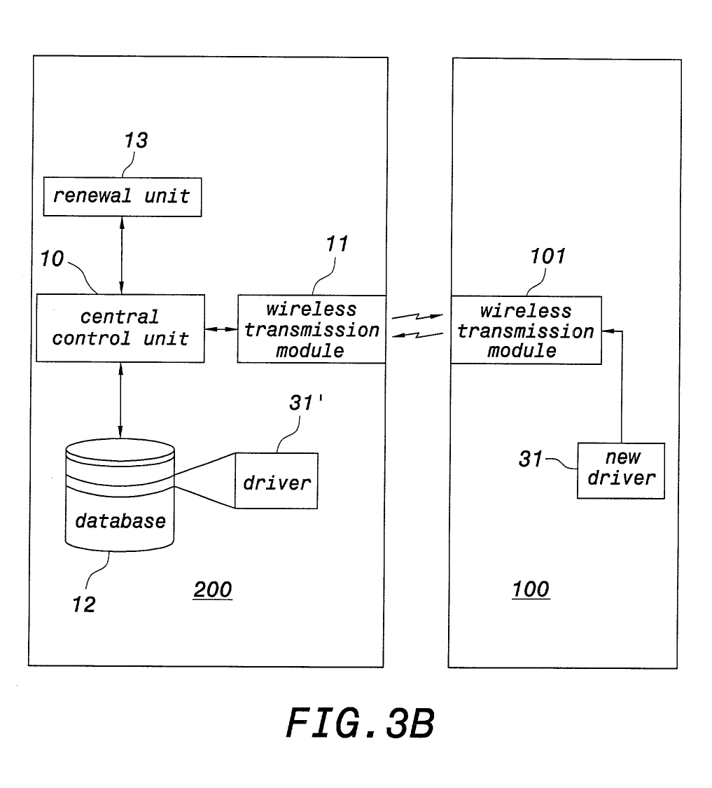

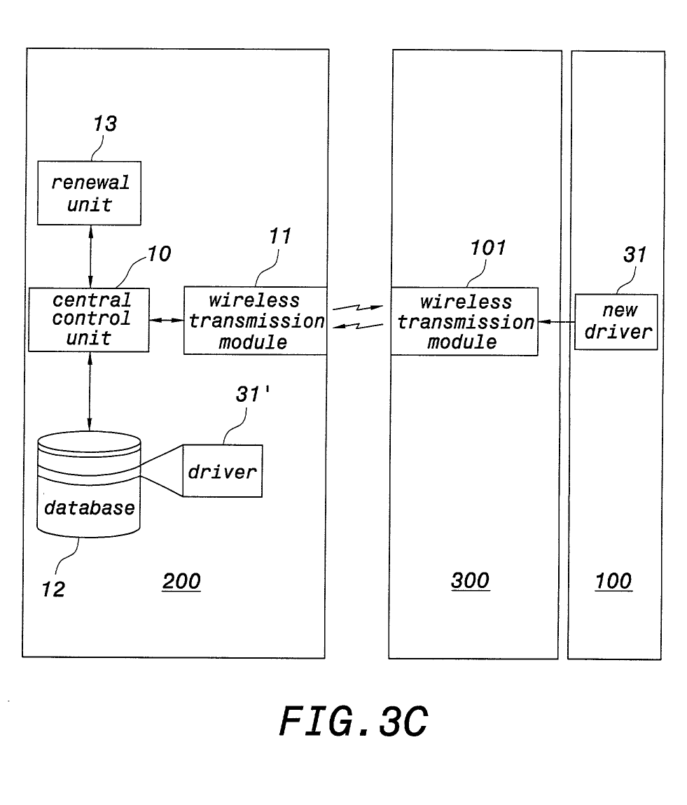

As shown in FIGS. 3A, 3B, and 3C, the database 12 in the wireless peripheral 200 of the present invention stores a driver capable of driving the wireless peripheral 200. Because the operation system of a computer will be upgraded once every one and half a year in average, the driver needs to be renewed along with upgrade of the operation system. Please also refer to FIG. 1. In order that the driver can be renewed, a renewal unit 13 is further provided in the present invention. The renewal unit 13 can utilize the host computer 100 to transmit new drivers and store or record them in the database 12 of the wireless peripheral 200. Renewal of drivers of the renewal unit 12 can be divided into three modes.

1. The database 12 in the wireless peripheral 200 is directly changed into a database 12 with new drivers. For instance, if the database 12 is an EEPROM, the database 12 is pulled out and directly replaced with a database 12′ with new drivers, as shown in FIG. 3A.

2. New drivers 31 are first stored in the host computer 100 having the wireless transmission module 101, and are then transferred to the wireless peripheral 200 via the wireless transmission module 101 and stored into the database 12 to replace the original drivers 31′ or store other drivers, as shown in FIG. 3B. Or the new drivers are transferred into the wireless peripheral 200 in wired transmission way.

3. New drivers 31 are first stored in the host computer 100, transferred into a relay device 300 having a wireless transmission module, and finally transferred into the wireless peripheral 200 via the wireless transmission module 101 and stored into the database 12 to replace the original drivers 31′ or store other drivers, as shown in FIG. 3C.

To sum up, the present invention is characterized in that a user needs not to confront complicated configurations of operational environment. No matter at the wireless peripheral end or the host computer end, the technique of the present invention can achieve the following objects: 1. Automatically detecting configurations of a computer; 2. Automatically loading and installing drivers; 3. Being capable of renewing drivers in a wireless peripheral. The present invention can apply to all computer peripherals or electronic products requiring wireless connection, thereby automatically building systematic integration in wireless communication way. A user thus needs not to learn various kinds of different interfaces of usage.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A wireless peripheral with inbuilt drivers of a host computer, said host computer having a wireless transmission module capable of transmitting control information to control actions of said wireless peripheral, said wireless peripheral comprising:
a wireless transmission module being capable of achieving communication with said wireless transmission module of said host computer;
a central processing unit being a control center of said wireless peripheral and being capable of performing transmission of control commands with said host computer, installation or renewal of drivers, and retrieval of parameters on said host computer via said wireless transmission modules;
a database storing one or more driver therein; moreover, said database having memory storage functionalities which can store functional properties or driver's installation information of said host computer; and
a renewal unit being capable of storing or recording new drivers into said database via said host computer.

2. The wireless peripheral with inbuilt drivers as claimed in claim 1, wherein communication protocols used by said wireless transmission module include IrDA, bluetooth, 802.11x, RF, Hiper LAN, IR, and laser transmission.

3. The wireless peripheral with inbuilt drivers as claimed in claim 1, wherein said wireless transmission module can use a wired I/O interface to achieve connection with said host computer.

4. The wireless peripheral with inbuilt drivers as claimed in claim 1, wherein said wireless transmission module can use a relay device having a wireless transmission module to achieve connection with said host computer.

5. The wireless peripheral with inbuilt drivers as claimed in claim 1, wherein said host computer can be a computer equipment having a wireless transmission module such as a desktop computer, a mainframe, a server, or a portable computer.

6. The wireless peripheral with inbuilt drivers as claimed in claim 1, wherein said host computer can be a small personal equipment having a wireless transmission module such as a handheld computer, a PDA, or a mobile phone.

7. The wireless peripheral with inbuilt drivers as claimed in claim 1, wherein said wireless peripheral can be a computer peripheral having a wireless transmission module such as a printer, a screen, a digital board, a mouse, a scanner, a modem, a network equipment, or any computer's device which has capability of wireless transmission.

8. The wireless peripheral with inbuilt drivers as claimed in claim 1, wherein said wireless peripheral can be a small personal equipment having a wireless transmission module such as a handheld computer, a PDA, or a mobile phone.

9. The wireless peripheral with inbuilt drivers as claimed in claim 1, wherein said database can be an EEPROM, a flash memory, a disk, a hard disk, an optical disk such as a CD/VCD/DVD, a portable flash memory such as a CF card, a SM card, a secure Digital, a Multi Media Card, a Memory Stick, or a Memory Stick Duo.
